(19) United States
(12) Patent Application Publication
(10) Pub. No.: US 2024/0388227 A1
(43) Pub. Date: Nov. 21, 2024

(54) DRIVE CONTROL DEVICE

(71) Applicant: RISO KAGAKU CORPORATION, Tokyo (JP)

(72) Inventors: Hideaki INOUE, Tokyo (JP); Hiroyuki SUNAGAWA, Tokyo (JP); Yoshihiro HANAMOTO, Tokyo (JP)

(73) Assignee: RISO KAGAKU CORPORATION, Tokyo (JP)

(21) Appl. No.: 18/640,083

(22) Filed: Apr. 19, 2024

(30) Foreign Application Priority Data
May 16, 2023 (JP) 2023-080710

(51) Int. Cl. H02P 7/29; H02P 6/08

(52) U.S. Cl. CPC H02P 7/29; H02P 6/08

(57) ABSTRACT

A drive control device includes: a processor, and a memory storing instructions that, when executed by the processor, cause the processor to perform operations. The operations include: calculating a duty ratio of a PWM signal based on a rotation speed of a motor driven by a PWM control and a target rotation speed; and obtaining an estimate value of a torque of the motor based on the rotation speed of the motor and the calculated duty ratio.

### CROSS-REFERENCE TO RELATED APPLICATIONS

The present application is based on and claims the benefit of priority from the prior Japanese Patent Application No. 2023-080710, filed on May 16, 2023, the entire contents of which are incorporated by reference herein.

### TECHNICAL FIELD

The present disclosure relates to a drive control device for driving a motor.

### BACKGROUND

There is a case where it is desired to estimate the torque of a motor during driving. For example, in a printer having a motor for driving a conveying roller for conveying paper used for printing, there is a requirement to estimate the torque of the motor in order to detect abnormalities such as wear and deterioration of the conveying roller.

Japanese Patent Application Publication No. 2020-35394 proposes to detect a current flowing through a motor and to convert the detected current into a torque by using a proportional characteristic between the torque generated by the motor and the current flowing through the motor.

### SUMMARY OF THE INVENTION

In the above-mentioned technique, a circuit for detecting a current flowing through the motor is required. This leads to an increase in size of the drive control device of the motor.

The present disclosure is directed to a drive control device capable of estimating the torque of a motor while suppressing the increase in size of the device.

A drive control device in accordance with some embodiments includes: a processor; and a memory storing instructions that, when executed by the processor, cause the processor to perform operations. The operations include: calculating a duty ratio of a PWM signal based on a rotation speed of a motor driven by a PWM control and a target rotation speed; and obtaining an estimate value of a torque of the motor based on the rotation speed of the motor and the calculated duty ratio.

According to the above configuration, the torque of the motor can be estimated while suppressing the increase in size of the device.

### BRIEF DESCRIPTION OF DRAWINGS

FIG. 1 is a schematic configuration diagram of a drive control device according to a first embodiment.

FIG. 2 is a diagram showing an example of a relationship between a measured value of torque of a motor and a rotation number for each duty ratio of a PWM signal.

FIG. 3 is a diagram showing slope and intercept of a characteristic line of the torque of the motor for each duty ratio of the PWM signal extracted from the measured value of the torque of the motor shown in FIG. 2.

FIG. 4 is a diagram showing an example of the slope and intercept of the characteristic line of the torque of the motor in the first embodiment.

FIG. 5 is a diagram showing an example of the slope and intercept of the characteristic line of the torque of the motor in a second embodiment.

FIG. 6 is a diagram showing a part of a graph comparing the intercepts shown in each of FIGS. 3, 4, and 5.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for embodiments of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

### First Embodiment

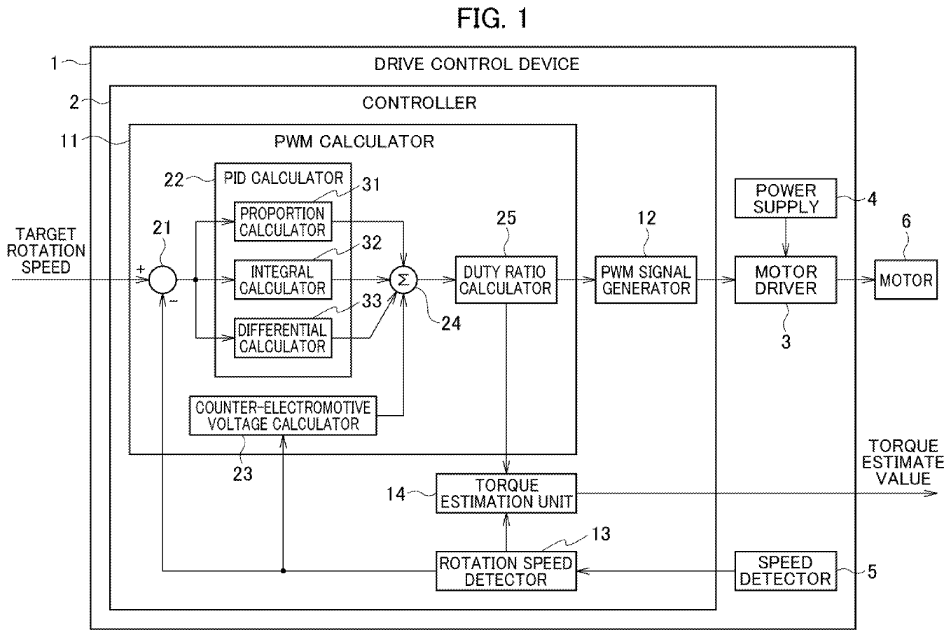

FIG. 1 is a schematic configuration diagram of a drive control device 1 according to a first embodiment of the present invention. As shown in FIG. 1, the drive control device 1 includes a controller 2, a motor driver 3, a power supply 4, and a speed detector 5.

The drive control device 1 drives a motor 6 which is a DC motor. The motor 6 drives a conveying roller for conveying paper in a printer, for example.

The controller 2 controls the motor driver 3 by a pulse width modulation (PWM) control. The controller 2 is composed of a microcomputer and the like provided with a storage and the like including a central processing unit (CPU), a memory and the like. The storage stores instructions that causes a processor to perform operations described below when executed by the processor such as a CPU. The storage may be provided outside the microcomputer. The controller 2 includes a PWM calculator (equivalent to a calculator) 11, a PWM signal generator 12, a rotation speed detector 13, and a torque estimation unit 14. Each part of the controller 2 is constituted by execution of a program and the like by the CPU.

The PWM calculator 11 calculates a duty ratio of the PWM signal based on a rotation speed of the motor 6 and a target rotation speed. The PWM calculator 11 includes a subtractor 21, a PID calculator 22, a counter-electromotive voltage calculator 23, an adder 24, and a duty ratio calculator 25.

The subtractor 21 subtracts the rotation speed of the motor 6 detected by the rotation speed detector 13 from the target rotation speed which is a target value of the rotation speed of the motor 6 to calculate a speed deviation.

The PID calculator 22 performs PID operation based on the speed deviation calculated by the subtractor 21. The PID calculator 22 includes a proportion calculator 31, an integral calculator 32, and a differential calculator 33.

The proportion calculator 31 calculates a proportion calculation value by multiplying the speed deviation by the proportional gain.

The integral calculator 32 calculates an integral calculation value by integrating the speed deviation in time and multiplying an obtained value (displacement amount) by an integral gain.

The differential calculator 33 calculates a differential calculation value by differentiating the speed deviation in time and multiplying an obtained value (acceleration) by a differential gain.

A counter-electromotive voltage calculator 23 calculates the counter-electromotive voltage of the motor 6 by multiplying a counter-electromotive voltage constant by the rotation speed of the motor 6 detected by the rotation speed detector 13. The counter-electromotive voltage is a voltage generated by the rotation of the motor 6 itself.

The adder 24 adds the proportion calculation value calculated by the proportion calculator 31, the integral calculation value calculated by the integral calculator 32, the differential calculation value calculated by the differential calculator 33, and the counter-electromotive voltage calculated by the counter-electromotive voltage calculator 23 to calculate the drive voltage of the motor 6.

The duty ratio calculator 25 calculates the duty ratio of the PWM signal corresponding to the drive voltage calculated by the adder 24.

The PWM signal generator 12 generates the PWM signal of the duty ratio calculated by the duty ratio calculator 25.

The rotation speed detector 13 calculates the rotation speed of the motor 6 based on a cycle of a pulse signal output by the speed detector 5.

The torque estimation unit 14 obtains an estimate value (torque estimate value) of the torque of the motor 6 based on the rotation speed of the motor 6 detected by the rotation speed detector 13 and the duty ratio of the PWM signal calculated by the duty ratio calculator 25.

The motor driver 3 drives the motor 6 based on the PWM signal generated by the PWM signal generator 12.

The power supply 4 supplies voltage to the motor driver 3.

The speed detector 5 outputs a pulse signal corresponding to a rotation angle of the motor 6. The speed detector 5 is composed of, for example, a rotary encoder.

Next, the operation of the drive control device 1 will be described.

During the driving of the motor 6, the speed detector 5 outputs a pulse signal corresponding to the rotation angle of the motor 6. The rotation speed detector 13 calculates the rotation speed of the motor 6 based on the cycle of the pulse signal output by the speed detector 5, and outputs the calculated rotation speed to the subtractor 21, the counter-electromotive voltage calculator 23, and the torque estimation unit 14.

The subtractor 21 subtracts the rotation speed inputted by the rotation speed detector 13 from the target rotation speed to calculate the speed deviation, and outputs the calculated speed deviation to the proportion calculator 31, the integral calculator 32, and the differential calculator 33 of the PID calculator 22.

In the PID calculator 22, the proportion calculator 31 calculates a proportion calculation value based on the speed deviation. The integral calculator 32 calculates an integral calculation value based on the speed deviation. The differential calculator 33 calculates a differential calculation value based on the speed deviation. The proportion calculator 31, the integral calculator 32 and the differential calculator 33 output the proportion calculation value, the integral calculation value and the differential calculation value to the adder 24 respectively calculated.

The counter-electromotive voltage calculator 23 calculates the counter-electromotive voltage of the motor 6 based on the rotation speed inputted by the rotation speed detector 13 and outputs the calculated counter-electromotive voltage to the adder 24.

The adder 24 calculates the drive voltage of the motor 6 by adding the proportion calculation value, the integral calculation value, the differential calculation value and the counter-electromotive voltage, and outputs the calculated drive voltage to the duty ratio calculator 25.

The duty ratio calculator 25 converts the drive voltage inputted by the adder 24 into the duty ratio of the PWM signal, and outputs the calculated duty ratio to the PWM signal generator 12.

The PWM signal generator 12 generates the PWM signal of the duty ratio inputted by the duty ratio calculator 25, and outputs the PWM signal to the motor driver 3.

The motor driver 3 applies a drive voltage corresponding to the PWM signal inputted by the PWM signal generator 12 to the motor 6. As a result, a current corresponding to the inductance of the motor 6, the resistance in the winding of the motor 6, the drive voltage, and the counter-electromotive voltage flows to the motor 6, and the motor 6 generates a torque proportional to the current to be rotated. For example, a conveying roller of a printer connected to the motor 6 is driven by the rotation of the motor 6.

The torque estimation unit 14 calculates a torque estimate value based on the rotation speed inputted by the rotation speed detector 13 and the duty ratio inputted by the duty ratio calculator 25. A method for calculating the torque estimate value will be described below. The torque estimation unit 14 outputs the calculated torque estimate value to an external monitoring device. The monitoring device detects an abnormality such as wear or deterioration of the conveying roller of the printer connected to the motor 6 based on the torque estimate value of the motor 6.

Next, the method for calculating the torque estimate value will be described.

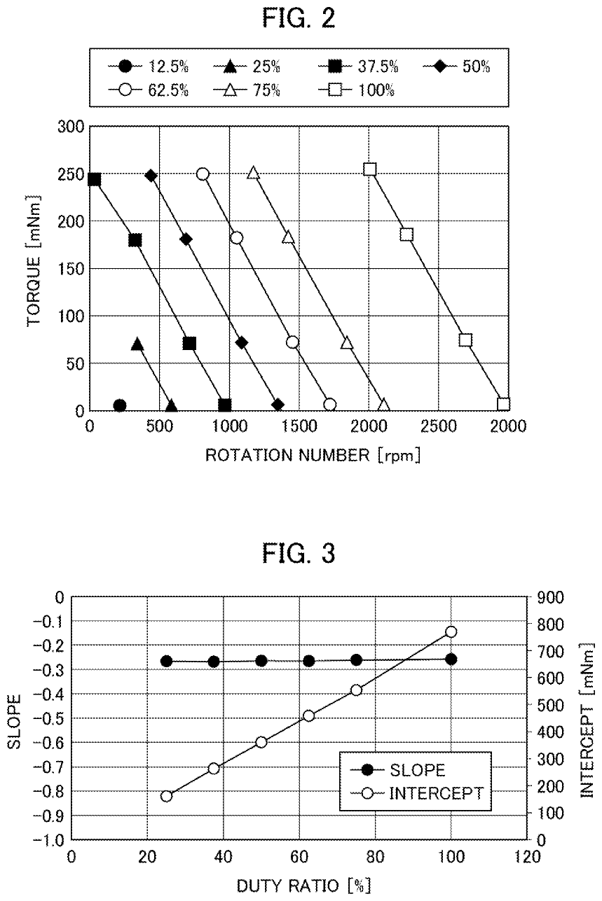

FIG. 2 is a diagram showing an example of a relationship between a measured value of a torque T of a motor 6 and a rotation number for each duty ratio P of a PWM signal in the drive control device 1. FIG. 2 shows that the characteristic line of the torque T showing the relationship between the torque T and the rotation number slides according to the duty ratio P.

As there is a proportional relationship between the rotation number and the rotation speed, the characteristic line of the torque T can be approximated by the following formula (1), which is a linear polynomial using the rotation speed ω of the motor 6 as a variable based on the relationship between the torque T and the rotation number shown in FIG. 2.

$$T = a \times ω + b \qquad ( 1 )$$

An intercept b in the formula (1) takes a value corresponding to the duty ratio P, since the characteristic line of the torque T slides according to the duty ratio P as described above. That is, the intercept b is a variable of the duty ratio P.

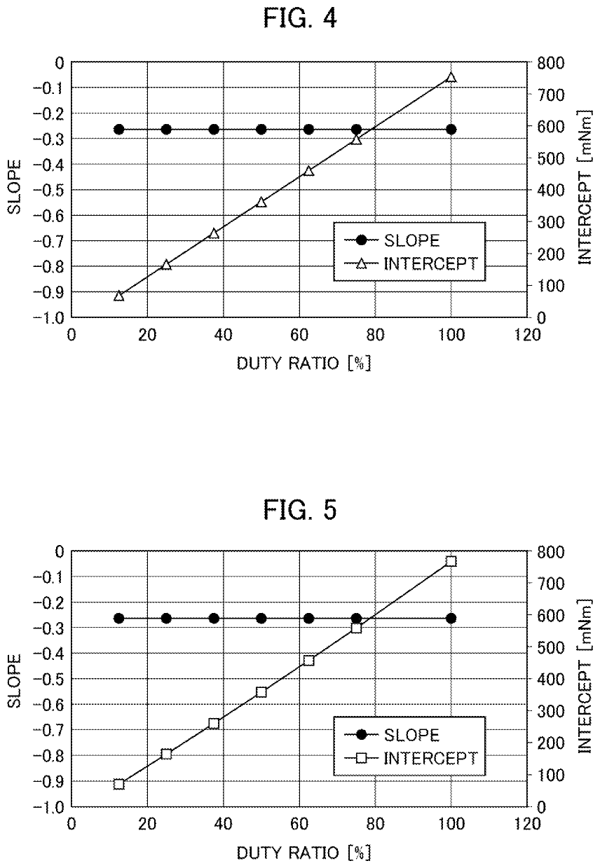

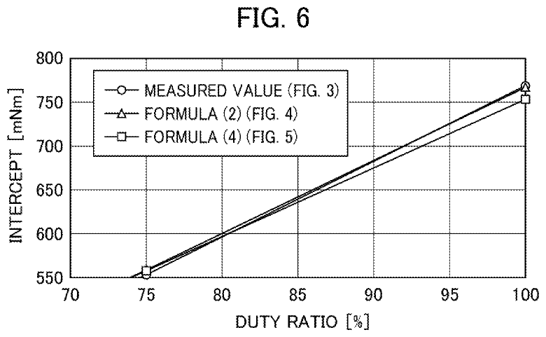

FIG. 3 shows the slope and intercept of the characteristic line of torque T for each duty ratio P extracted from the measured value of torque T shown in FIG. 2.

The slope a in formula (1) can be, for example, an average value of slope values for each duty ratio P shown in FIG. 3.

On the other hand, the intercept b in formula (1) can be approximated by the following formula (2), which is a linear polynomial using the duty ratio P as a variable, based on the relationship between the duty ratio P and the intercept in FIG. 3.

$$b = ba \times P + bb \qquad ( 2 )$$

The values of the slope ba and the intercept bb in formula (2) are the values of the slope and intercept of the regression line obtained by linearly approximating the values of the intercepts at each duty ratio P shown in FIG. 3.

The following formula (3) can be obtained from formulas (1) and (2).

$$T = a \times ω + ( ba \times P + bb ) \qquad ( 3 )$$

The torque estimation unit 14 calculates the torque T as a torque estimate value using the formula (3) based on the rotation speed ω inputted by the rotation speed detector 13 and the duty ratio P inputted by the duty ratio calculator 25, since the torque T is expressed by the formula (3). Here, a, ba, and bb in the formula (3) are coefficients corresponding to the characteristics of the torque of the motor 6 driven and controlled by the drive control device 1, and the values previously calculated by experiment or the like in the drive control device 1 are used as these values.

In the example shown in FIGS. 2 and 3, the slope a in the formula (1) and the intercept b in the formula (1) expressed by the formula (2) are calculated as shown in FIG. 4. In this example, the torque T is calculated as a torque estimate value using the formula (3) based on the slope a in FIG. 4 and the slope ba and the intercept bb of a straight line showing the intercept b.

As described above, in the drive control device 1, the torque estimation unit 14 obtains a torque estimate value based on the rotation speed of the motor 6 and the duty ratio of the PWM signal. Thus, the torque of the motor 6 can be estimated without providing a dedicated circuit such as a current detection circuit used to detect the current flowing in the motor 6 and convert it into a torque. Therefore, with the drive control device 1, the torque of the motor 6 can be estimated while suppressing increase in size of the device. In addition, the torque of the motor 6 can be estimated while suppressing increase in cost.

Specifically, the torque estimation unit 14 calculates a torque estimate value using formula (3) based on the rotation speed of the motor 6 and the duty ratio of the PWM signal. By calculating the torque estimate value using a formula, it is possible to estimate the torque of the motor 6 without providing a dedicated circuit.

### Second Embodiment

Next, a description will be given of a second embodiment in which the operation for obtaining a torque estimate value in the torque estimation unit 14 of the first embodiment described above is changed.

The intercept b of the aforementioned formula (1) can be approximated by the following formula (4), which is a quadratic polynomial with the duty ratio P as a variable.

$$b = bc \times {P}^{2} + bd \times P + be \qquad ( 4 )$$

The values of the coefficients bc, bd, and be in formula (4) are the coefficients of the quadratic formula obtained from the values of the intercepts at each duty ratio P shown in FIG. 3 by the quadratic approximation by the least squares method and the like.

The following formula (5) can be obtained from formulas (1) and (4).

$$T = a \times ω + ( bc \times {P}^{2} + bd \times P + be ) \qquad ( 5 )$$

In the second embodiment, the torque estimation unit 14 calculates the torque T as a torque estimate value using formula (5) based on the rotation speed ω inputted by the rotation speed detector 13 and the duty ratio P inputted by the duty ratio calculator 25. Here, the values of a, bc, bd, and be in formula (5) are coefficients corresponding to the characteristics of the torque of the motor 6 driven and controlled by the drive controller 1, and the values previously calculated by experiment or the like in the drive controller 1 are used as these values.

In the example shown in FIGS. 2 and 3, the intercept b in formula (1) represented by formula (4) is calculated as shown in FIG. 5. The slope a similar to that shown in FIG. 4 is also shown in FIG. 5. In this example, the torque T is calculated as a torque estimate value using formula (5) based on coefficients bc, bd, and be of a quadratic curve showing the slope a and the intercept b in FIG. 5.

A part of a graph comparing the intercepts shown in FIGS. 3, 4, and 5 is shown in FIG. 6. The intercept in FIG. 3 is the intercept of the characteristic line of torque T for each duty ratio P extracted from the measured value of torque T shown in FIG. 2, as described above. The intercepts in FIGS. 4 and 5 are the intercepts b represented by formulas (2) and (4), respectively, as described above.

As shown in FIG. 6, the intercept b represented by formula (4) is less deviated from the intercept of the characteristic line extracted from the measured value than the intercept b represented by formula (2). Therefore, the torque estimate value can be obtained with higher accuracy by formula (5) than by formula (3).

As described above, in the second embodiment, the torque estimation unit 14 calculates a torque estimate value using formula (5) based on the rotation speed of the motor 6 and the duty ratio of the PWM signal. That is, the torque estimation unit 14 calculates the intercept b of formula (1) using formula (4), which is a quadratic polynomial with the duty ratio P as a variable. Thus, the accuracy of the torque estimate value can be improved.

In the first and second embodiments described above, the torque estimate value was calculated by a formula based on the rotation speed of the motor 6 and the duty ratio of the PWM signal. However, the drive control device 1 may store a table relating the rotation speed, the duty ratio and the torque estimate value in advance, and the torque estimation unit 14 may refer to the table to obtain the torque estimate value based on the rotation speed and the duty ratio.

In the first embodiment described above, the intercept b in formula (1) is calculated using formula (2), which is a linear polynomial with the duty ratio P as a variable. In the second embodiment described above, the intercept b of formula (1) is calculated using formula (4), which is a quadratic polynomial with the duty ratio P as a variable. However, it is not limited to these, for example, the intercept b in formula (1) may be calculated using a polynomial of the third degree or higher with the duty ratio P as a variable.

The embodiment of the present disclosure has the following configuration, for example.

A drive control device includes: a processor; and a memory storing instructions that, when executed by the processor, cause the processor to perform operations. The operations include: calculating a duty ratio of a PWM signal based on a rotation speed of a motor driven by a PWM control and a target rotation speed; and obtaining an estimate value of a torque of the motor based on the rotation speed of the motor and the calculated duty ratio.

The operations may further include obtaining the estimate value based on the rotation speed of the motor and the calculated duty ratio, using a linear polynomial in which the rotation speed of the motor is a variable and whose intercept is a value corresponding to the duty ratio of the PWM signal.

The operations may further include calculating the intercept using a linear polynomial in which the duty ratio of the PWM signal is a variable.

The operations may further include calculating the intercept using a quadratic polynomial in which the duty ratio of the PWM signal is a variable.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

1. A drive control device comprising:
a processor; and
a memory storing instructions that, when executed by the processor, cause the processor to perform operations including:
calculating a duty ratio of a PWM signal based on a rotation speed of a motor driven by a PWM control and a target rotation speed; and
obtaining an estimate value of a torque of the motor based on the rotation speed of the motor and the calculated duty ratio.

2. The drive control device according to claim 1, wherein the operations further include obtaining the estimate value based on the rotation speed of the motor and the calculated duty ratio, using a linear polynomial in which the rotation speed of the motor is a variable and whose intercept is a value corresponding to the duty ratio of the PWM signal.

3. The drive control device according to claim 2, wherein the operations further include calculating the intercept using a linear polynomial in which the duty ratio of the PWM signal is a variable.

4. The drive control device according to claim 2, wherein the operations further include calculating the intercept using a quadratic polynomial in which the duty ratio of the PWM signal is a variable.
